(19) United States
(12) Patent Application Publication
(10) Pub. No.: US 2024/0051801 A1
(43) Pub. Date: Feb. 15, 2024

(54) CABLE SLACK CONTROL AND ASSOCIATED SYSTEMS AND METHODS

(71) Applicant: MineSense Technologies Ltd., Vancouver (CA)

(72) Inventors: Fadi Kanafani, Richmond (CA); Kamyar Jafari-Esfahani, Vancouver (CA); Luke Devall, Otley (GB)

(21) Appl. No.: 18/449,600

(22) Filed: Aug. 14, 2023

Related U.S. Application Data
(60) Provisional application No. 63/397,764, filed on Aug. 12, 2022.

(51) Int. Cl. B66D 1/50

(52) U.S. Cl. CPC B66D 1/50

(57) ABSTRACT

Cable slack control systems for controlling cable slack and associated systems and methods are disclosed herein. In some embodiments, a cable slack control system includes two sliding carriage assemblies that can slide toward or away from one another, and biasing members disposed in between the sliding carriage assemblies. Each sliding carriage assembly can include a plurality of pullies that each receive a portion of a cable extending through the cable slack control system. When the cable is pulled out of the system, the tension in the cable causes the sliding carriage assemblies to slide toward one another and the biasing members to compress, letting cable out of the cable slack control system. When tension in the cable is released, producing cable slack, the biasing members push the sliding carriage assemblies away from one another, drawing cable into the cable slack control system.

### CROSS-REFERENCE TO RELATED APPLICATION(S)

The present application claims the benefit of U.S. Provisional Patent Application No. 63/397,764, filed Aug. 12, 2022, the disclosure of which is incorporated herein by reference in its entirety.

### TECHNICAL FIELD

The present disclosure generally relates to cable slack control systems and, in particular embodiments, cable slack control systems for controlling cable slack during movement of mining equipment components and associated methods and systems.

### BACKGROUND

Cables are routed to various moving components of heavy machinery, such as mining shovels and other mining equipment. Given the varying length of cable needed to extend between moving components through their relative ranges of motion, cables must have excess length, i.e., slack. The excess length of the cable may be loose or otherwise unrestrained, which can cause the cable to hit or move against a surface, which can cause abrasion and wear on the cable, and or causing on-site personnel to trip over cable on the ground. Cable slack can also increase the risk of the cable becoming entangled with itself or another object, such as another cable. Furthermore, in an environment with moving parts or heavy machinery, excess cable may extend underneath moving tracks or wheels (e.g., of a crane or mining shovel), causing potential damage to the cable. However, the excess cable is important to allow the cable to extend as needed, for example, when the cable is connected to a moving component.

### BRIEF DESCRIPTION OF THE DRAWINGS

Many aspects of the present disclosure can be better understood with reference to the drawings in the following Detail Description. The components in the drawings are not necessarily to scale. Instead, emphasis is placed on clearly illustrating the principles of the present disclosure.

FIG. 1 is a perspective view of a cable slack control system configured in accordance with embodiments of the present technology.

FIG. 2A is a perspective view of the cable slack control system of FIG. 1 with external panels removed to illustrate internal features of the cable slack control system in accordance with embodiments of the present technology.

FIG. 2B is an enlarged perspective view of a sliding carriage assembly of the cable slack control system of FIG. 2A in accordance with embodiments of the present technology.

FIG. 2C is an enlarged perspective view of a pulley array assembly of the sliding carriage assembly of FIG. 2B in accordance with embodiments of the present technology.

FIGS. 3A-3C are perspective views of the cable slack control system of FIG. 2A in various slack control positions in accordance with embodiments of the present technology.

FIG. 4 is a perspective view of a mining shovel including a cable slack control system in accordance with embodiments of the present technology.

FIG. 5 is a perspective view of a mining shovel including a cable slack control system in accordance with embodiments of the present technology.

### DETAILED DESCRIPTION

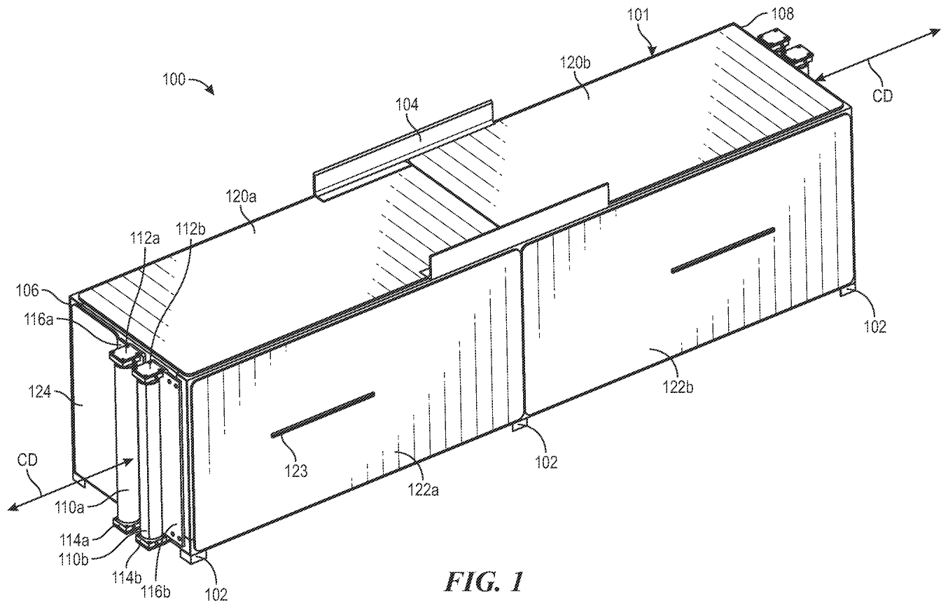

The present technology is directed generally to cable slack control systems for controlling slack (e.g., excess, loose lengths) of cables and the like, and associated systems and methods. In some embodiments, for example, a cable slack control system can include first and second sliding carriage assemblies and one or more springs dispose in between. Each sliding carriage assembly can include multiple pullies, and a cable can be looped around individual ones of the pullies, alternating between the first and second sliding carriage assemblies. When the cable is pulled from the cable slack control system the tension in the cable can cause the first and second sliding carriage assemblies to move toward each other and thereby provide additional cable length. When the cable is loosened, creating slack, the one or more springs can push the first and second sliding carriage assemblies to move away from each other and thereby draw in the slack. Specific details of several embodiments of the present technology are described herein with reference to FIGS. 1-5. The present technology, however, can be practiced without some of these specific details. In some instances, well-known structures and techniques often associated with optical sensors and mining equipment have not been shown in detail so as not to obscure the present technology. The terminology used in the description presented below is intended to be interpreted in its broadest reasonable manner, even though it is being used in conjunction with a detailed description of certain specific embodiments of the disclosure. Certain terms can even be emphasized below; however, any terminology intended to be interpreted in any restricted manner will be overtly and specifically defined as such in this Detailed Description section.

The accompanying Figures depict embodiments of the present technology and are not intended to be limiting of its scope. The sizes of various depicted elements are not necessarily drawn to scale, and these various elements can be arbitrarily enlarged to improve legibility. Component details can be abstracted in the Figures to exclude details such as position of components and certain precise connections between such components when such details are unnecessary for a complete understanding of how to make and use the present technology. Many of the details, dimensions, angles, and other features shown in the Figures are merely illustrative of particular embodiments of the disclosure. Accordingly, other embodiments can have other details, dimensions, angles, and features without departing from the spirit or scope of the present technology.

The following disclosure describes various embodiments of and associated systems, components, and methods for use with, for example, industrial mining equipment and/or rugged sensors. The cable slack control system configured in accordance with the present technology can be mounted to a surface or component of the mining equipment (e.g., the crane body, the mining shovel body, the boom, the bucket, various linkage, the bucket arm, the dipper handle, main cabin, etc.) and control slack in a cable extending through the cable slack control system. In operation, the cable slack control system can reduce the strain on the cable as the movement of the mining equipment requires greater cable length, and also taking up extraneous length of the cable when a shorter length is needed. This can be of particular importance with electrical cables that connect to sensors, cameras, and/or other components positioned on a movable portion of the mining equipment (e.g., a mining shovel bucket).

As used herein, the term “cable” can refer to various types of cables (e.g., electrical, fiber optic, metallic, coaxial, etc.), lines, ropes, string, and/or other elongated structures that are used to mechanically and/or electrically connect two structures and move relative thereto. These cables may include shielding, sheathing, other types of coverings and/or coatings, and/or one or more of these coverings or coatings may be omitted. Embodiments of the snatch roller fairlead assemblies described herein can be used with various cable or line sizes and/or materials, and some embodiments of the snatch roller fairlead assemblies may be designed to work with two or more different types of cables or lines (at the same time or separately).

FIG. 1 is a perspective view of a cable slack control system 100 (“system 100”) configured in accordance with embodiments of the present technology. The system 100 can include a housing 101 having a first end portion 106 and a second end portion 108, one or more base foots 102 attached to various points on an underside of the housing 101, and one or more mounting brackets 104 attached to the housing 101. On each of the first and second end portions 106, 108, the system 100 can further include first and second roller brackets 116a, 116b, first upper and first lower receivers 112a, 114a operatively coupled to the first roller bracket 116a, second upper and second lower receivers 112b, 114b operatively coupled to the second roller bracket 116b, a first roller 110a rotatably coupled between first upper and lower receivers 112a, 114a, and a second roller 110b rotatably coupled between second upper and lower receivers 112b, 114b (collectively referred to as rollers 110″).

The housing 101 can include first and second upper panels 120a, 120b (collectively referred to as “upper panels 120”), first and second side panels 122a, 122b and third and fourth side panels (obscured from view) opposite the first and second side panels 122a, 122b (collectively referred to as “side panels 122”), an end panel 124 on each of the first and second end portions 106, 108 (the end panel on the second end portion 108 being obscured from view), and base panels (obscured from view) opposite from the upper panels 120. In some embodiments, individual ones of the side panels 122 can include one or more slots or openings 123. Each of the aforementioned panels can be made from plastic (e.g., polyurethane), metal (e.g., aluminum, steel), or other materials, and can have any suitable dimensions (e.g., length, width, thickness).

Each of the rollers 110 can be made from plastic (e.g., polyurethane), plastic coated with metal (e.g., steel), metal (e.g., aluminum, steel), or other materials. In some embodiments, the diameter of each of the rollers 110 can range between 50 mm and 100 mm (e.g., 60 mm), or other dimensions. In some embodiments, the length of each of the rollers 110 can range between 350 mm and 650 mm (e.g., 500 mm), or other dimensions. In some embodiments, the coupling between the rollers 110 and the receivers 112a, 112b, 114a, 114b can include friction-reducing components such as ball or needle bearings, bushings, low-friction surfaces, etc. to aid in the rotation of the rollers 110. In some embodiments, at least a portion of the surfaces of the rollers 110 can be coated in a wear-resistant material (e.g., polyurethane, polyoxymethylene thermoplastic, rubber, or the like). In the illustrated embodiment, the rollers 110 are oriented vertically (e.g., from the base panel toward the upper panels 120). In other embodiments, the rollers 110 can be oriented at different angles (e.g., horizontally, at 45 degrees from the vertical).

During operation, the base foots 102 can be fixedly, removably, slidably attached to a surface (e.g., a floor, an external surface of a crane or bucket), or placed thereon to support the housing 101. The mounting brackets 104 can be attached to a surface (e.g., bottom of a viewing deck on a crane or mining shovel, an external surface of a raised structure) to suspend the housing 101 therefrom. In some embodiments, the base foots 102 and/or the mounting brackets 104 can be attached to the surface(s) via fasteners (e.g., clamps, pins, screws, bolts, hinges, mating surface connectors), connection methods (e.g., welding, adhesives), and/or other coupling mechanisms. In some embodiments, the base foots 102 and/or the mounting brackets 104 can be integrally formed with the housing 101.

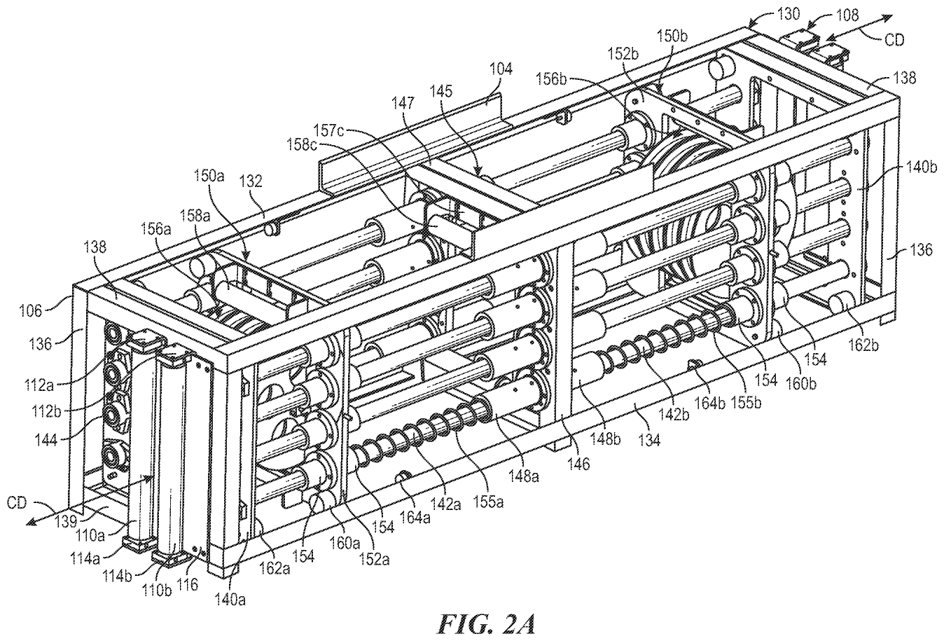

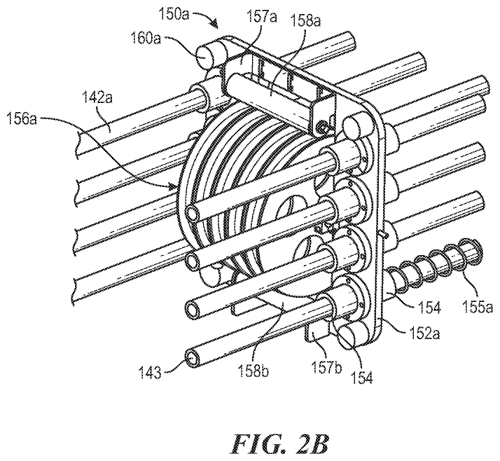

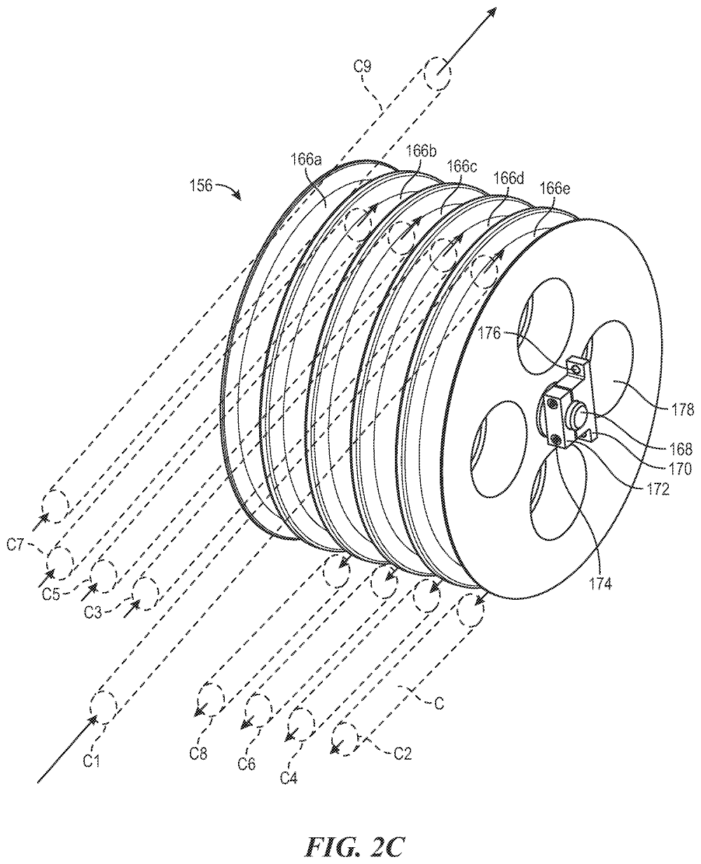

The system 100 can be configured to route a cable (not shown) in a bidirectional cable direction CD, extending from in between the rollers 110 on the first end portion 106, through the housing 101, and to in between the rollers (partially obscured from view) on the second end portion 108. The first and second roller brackets 116a, 116b can be configured to allow lateral adjustment of the first and second rollers 110, respectively, to accommodate cables of varying sizes (e.g., diameters). The various panels of the housing 101 can protect the internal components of the system 100, which will be described in further detail below with respect to FIGS. 2A-C. The slots or openings 123 can provide visual access for inspection (e.g., to determine cable operation length state) or cooling of the internal components of the system 100.

FIG. 2A is a perspective view of the system 100 with the housing 101 removed in accordance with embodiments of the present technology. As shown, the system 100 can further include a frame assembly 130, first and second endplates 140a, 140b (collectively referred to as “endplates 140”) coupled to the frame assembly 130 proximate to the first end portion 106 and the second end portion 108, respectively, and an intermediate support structure 145 coupled to a central portion of the frame assembly 130 (e.g., between the endplates 140). The system 100 can further include a first plurality of rods 142a extending between the first endplate 140a and the intermediate support structure 145, and a second plurality of rods 142b extending between the second endplate 140b and the intermediate support structure 145 (collectively referred to as “rods 142”), a first sliding carriage assembly 150a slidably coupled between the first endplate 140a and the intermediate support structure 145, a second sliding carriage assembly 150b slidably coupled between the second endplate 140b and the intermediate support structure 145 (collectively referred to as “sliding carriage assemblies 150”), and one or more first and second biasing members 155a, 155b such as compression springs or torsional springs (collectively referred to as “biasing members 155) disposed between the sliding carriage assemblies 150.

In the illustrated example, the frame assembly 130 includes upper beams 132, lower beams 134, end columns 136, and crossbeams 138 interconnected to form a generally prismatic shape. Each of the upper panels 120, the side panels 122, the end panels 124, and the base panels shown and/or described above with respect to FIG. 1 can be attached to the frame assembly 130 via fasteners, magnet, and/or other coupling mechanisms. Each of the components of the frame assembly 130 can be made from plastic (e.g., polyurethane), metal (e.g., aluminum, steel), or other materials. In some embodiments, the frame assembly 130 can have a length that ranges between 1650 mm and 2550 mm (e.g., 2250 mm), a height that ranges between 450 mm and 700 mm (e.g., 570 mm), and a width that ranges between 450 mm and 700 mm (e.g., 540 mm). The frame assembly 130 can have other dimensions. In some embodiments, bump stops 164a, 164b can be attached along the upper beams 132 and/or the lower beams 134.

Each of the endplates 140 can be coupled to the frame assembly 130 at a fixed position via fasteners, welding, or other coupling mechanisms. Each of the endplates 140 can include one or more apertures each configured to receive one of the rods 142. In some embodiments, one or more rod clamps 144 can be attached to each of the endplates 140 in order to clamp onto or otherwise support and restrict axial movement of the rods 142. In the illustrated embodiment, each of the first and second pluralities of rods 142a, 142b includes eight rods, four on each side of the frame assembly 130, and the system 100 includes a corresponding number of rod clamps 144. In some embodiments, the rods 142 can be welded, fastened, or otherwise coupled to the endplates 140. In some embodiments, one or more bump stops 162a, 162b can be attached to the sides of the endplates 140 facing the intermediate support structure 145.

The intermediate support structure 145 can similarly include one or more apertures each configured to receive one of the rods 142. In some embodiments, a first plurality of rod receivers 148a can be attached to a first side of the intermediate support structure 145 (e.g., facing the first end portion 106), and a second plurality of rod receivers 148b can be attached to a second side of the intermediate support structure 145 (e.g., facing the second end portion 108) (collectively referred to as “rod receivers 148”). Each of the rod receivers 148 can have fasteners such as set screws (not shown) and/or provide an interface/close fit to further secure and minimize movement of the rods 142. The rod receivers 148 can have a diameter that ranges between 50 mm and 100 mm (e.g., 70 mm), or other dimensions. The rod receivers 148 can have lengths that range between 125 mm and 250 mm (e.g., 175 mm), or other dimensions. In some embodiments, retention rollers 158c rotatably coupled to roller brackets 157c of the intermediate support structure 145. In some embodiments, the intermediate support structure 145 can be omitted from the system 100.

The rods 142 can be made from plastic (e.g., polyurethane), metal (e.g., aluminum, steel), or other materials. In some embodiments, the diameter of each rod 142 can range between 25 mm and 55 mm (e.g., 40 mm), or other dimensions. In some embodiments, the length of each rod 142 can range between 1500 mm and 2400 mm (e.g., 2100 mm), or other dimensions. In some embodiments, individual ones of the first plurality of rods 142a are integrally formed with individual ones of the second plurality of rods 142b.

In the illustrated embodiment, the biasing members 155 are wound around one of the rods 142 and at least partially compressed between the intermediate support structure 145 and each of the sliding carriage assemblies 150. In FIG. 2A, the biasing members 155 are shown wound around only two of the rods 142 to avoid obscuring certain features of the technology. In some embodiments, the biasing members 155 can be wound around different ones of the rods, a greater number of rods, and/or all of the rods 142. In some embodiments, the intermediate support structure 145 is omitted and biasing members 155 can fully extend between the sliding carriage assemblies 150. Each of the biasing members 155 can have a spring constant that ranges between 1.5 N/mm and 2.5 N/mm (e.g., 1.86 N/mm).

FIG. 2B is an enlarged perspective view of the first sliding carriage assembly 150a. It is appreciated that in some embodiments, the second sliding carriage assembly 150b can include similar or identical components. As shown, the first sliding carriage assembly 150a can comprise a first sliding plate 152a including one or more apertures each configured to receive one of the rods 142, one or more bearings 154 (e.g., plain bearing, ball bearing, roller bearing) attached to one or both sides of the first sliding plate 152a and configured to slidably receive the rods 142, a first pulley array assembly 156a rotatably coupled to the first sliding plate 152a, first and second roller brackets 157a, 157b attached to upper and lower portions of the first sliding plate 152a, first and second retention rollers 158a, 158b rotatable coupled to the first and second roller brackets 157a, 157b, respectively, and one or more bump stops 160a attached to either or both sides of the first sliding plate 152a (e.g., at the corners, as shown). In some embodiments, individual ones of the rods 142 can include apertures 143 for weight reduction.

FIG. 2C is an enlarged perspective view of the second pulley array assembly 156b. It is appreciated that in some embodiments, the first pulley array assembly 156a can include similar or identical components. The second pulley array assembly 156b can include a plurality of pulleys 166a, 166b, 166c, 166d, 166e (collectively referred to as “pulleys 166”) in a stacked arrangement, a shaft 168 extending through central apertures of the pulleys 166, and base and upper clamp portions 170, 172 that clamp a distal end portion of the shaft 168. The upper clamp portion 172 can include apertures 174 configured to receive fasteners for coupling the base and upper clamp portions 170, 172 together. The base clamp portion 170 can include apertures 176 configured to receive fasteners for coupling the base clamp portion 170 to the sliding plate 152 (FIG. 2B).

Each of the pulleys 166 can be made from plastic, metal (e.g., aluminum, steel), or other materials. In some embodiments, the diameter of each pulley 166 can range between 250 mm and 450 mm (e.g., 350 mm), or other dimensions. In some embodiments, the width of each pulley 166 can range between 30 mm and 55 mm (e.g., 44 mm), or other dimensions. In some embodiments, individual ones of the pulleys 166 can include one or more apertures 178 for weight reduction.

In operation of the system 100, a cable can extend in between the rollers 110 at the first end portion (FIG. 2A), extend over (but not around) a first of the pulleys of the first pulley array assembly 156a, and extend toward pulley 166e of the second pulley array assembly 156b, as represented by phantom cable portion C1 in FIG. 2C. The cable can loop around half of pulley 166e and extend toward a second one of the pulleys of the first pulley array assembly 156a, as represented by phantom cable portion C2. The cable can then loop around half of the second one of the pulleys of the first pulley array assembly 156a and extend toward pulley 166d, as represented by phantom cable portion C3. Repeating this pattern for phantom cable portions C4-8, the cable can the loop around half of a last (e.g., fifth) one of the pulleys of the first pulley array assembly 156a, extend over (but not around) pulley 166a, as represented by phantom cable portion C9, and extend in between the rollers 110 at the second end portion 108 and out of the system 100 (FIG. 2A).

In some embodiments, the pulleys 166 can rotate on the shaft 168 together or independently of one another as the cable moves within the system 100. The retention rollers 158a, 158b included in each of the sliding carriage assemblies 150 can help guide the cable portions and keep the cable portions on individual ones of the pulleys 166. The retention rollers 158c can similarly help guide the cable portions extending between the sliding carriage assemblies 150. The retention rollers 158 can also help prevent a cable jump, twist, exit, or other misalignment on the pulleys 166.

As described above, the cable can be configured to be wound alternately around the first and second pulley array assemblies 156a, 156b. In some embodiments, the first and second pulley array assemblies 156a, 156b can have the same number of pulleys 166. In some embodiments, the first and second pulley array assemblies 156a, 156b can have different numbers of pulleys 166. In some embodiments, the number of pulleys 166 included in each pulley array assembly 156 can be at least two, three, four, five, six, seven, eight, nine, or ten.

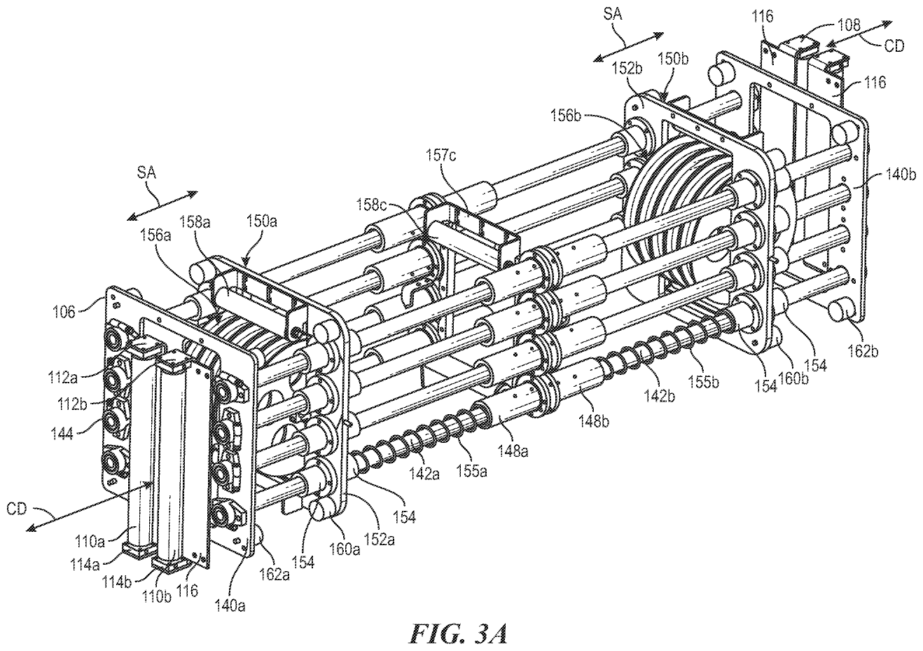

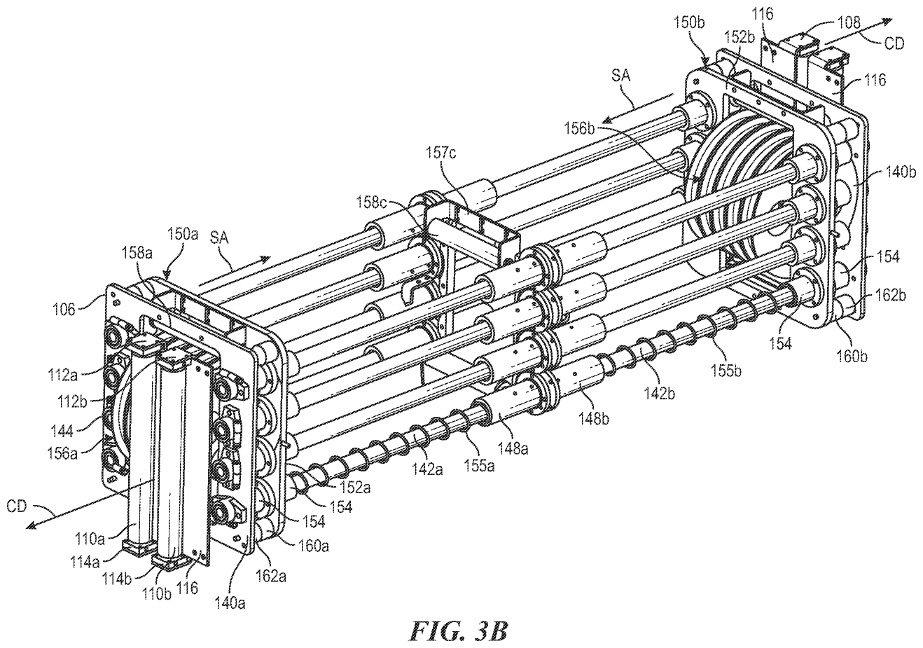

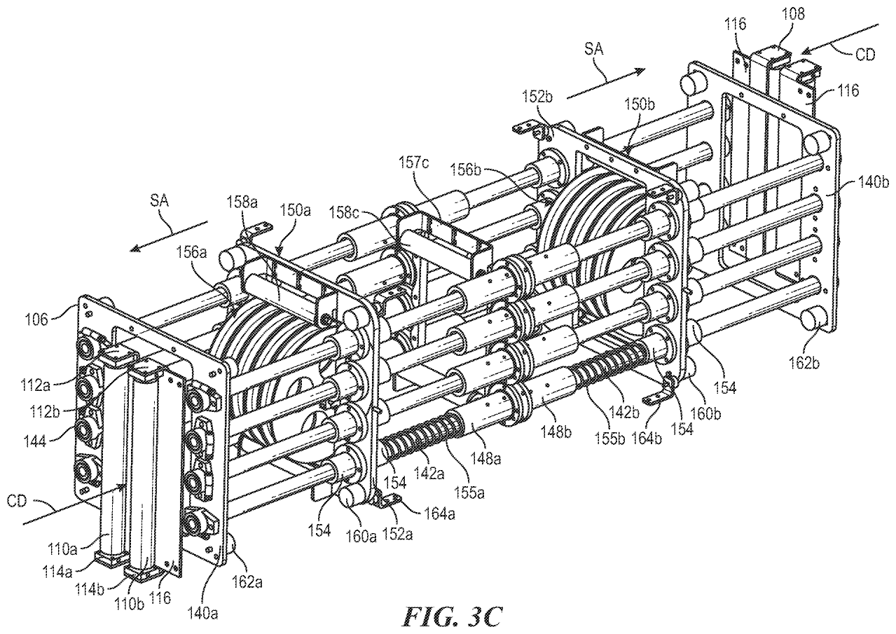

FIGS. 3A-3C are perspective views of the system 100 in various slack control positions in accordance with embodiments of the present technology. Specifically, FIG. 3A illustrates the system 100 in an intermediate slack control position, FIG. 3B illustrates the system 100 in a maximum slack control position, and FIG. 3A illustrates the system 100 in a minimum slack control position.

During operation of the system 100, a cable (not shown) can move in direction CD according to movement of an object to which the cable is attached. For example, the system 100 can be in the intermediate slack control position shown in FIG. 3A, allowing the sliding carriage assemblies 150 to move in either direction SA. Tension in the cable can keep the biasing members 155 compressed between the intermediate support structure 145 (not shown in FIGS. 3A-C) and either of the sliding carriage assemblies 150.

If one end of the cable extending out of the second end portion 108 is attached to a fixed object and the other end of the cable extending out of the first end portion 106 is attached to a mining shovel bucket that is moving toward the system 100, cable slack between the mining shovel bucket and the first end portion 106 can begin to form. As the cable tension decreases, the biasing members 155 can push the sliding carriage assemblies 150 out toward the first and second end portions 106, 108, resulting in the maximum slack control position shown in FIG. 3B. In some embodiments, the bump stops 160, 162 can stop the sliding carriage assemblies 150 from sliding farther out and prevent damage to components of the system 100. For example, without the bump stops 160, 162, the biasing members 155 can cause the sliding carriage assemblies 150 to hit the endplates 140 at a high velocity, resulting in damaged components.

When the system 100 is in the maximum slack control position shown in FIG. 3B, the sliding carriage assemblies 150 can be in contact with their respective endplates 140 (e.g., via the bump stops 160, 162) and the biasing members 155 can be in a minimally compressed state. As a result, the distance between the sliding carriage assemblies 150 is at a maximum and so the length of cable within the system 100 is also at a maximum. Therefore, the system 100 can no longer pull in any further cable slack and the system 100 is ideally configured such that cable only moves in direction CD, causing the sliding carriage assemblies 150 to move in directions SA, as shown in FIG. 3B. If the cable moves in the direction opposite to the illustrated directions CD, any resulting cable slack can cause the mechanical, electrical, and safety issues discussed above.

When the system 100 is in the minimum slack control position shown in FIG. 3C, the sliding carriage assemblies 150 can be in contact with the bump stops 164 attached to the frame assembly 130 (not shown in FIGS. 3A-C) and the biasing members 155 can be in a maximally compressed state allowed by the system 100. Similar to the bump stops 160, 162, the bump stops 164 can help prevent damage to the components when the cable is pulled out of the system 100 at a high velocity. As a result, the distance between the sliding carriage assemblies 150 is at a minimum and so the length of cable within the system 100 is also at a minimum. Therefore, the system 100 can no longer provide any more cable length to the moving components outside of the system 100 and the system 100 is ideally configured such that cable only moves in direction CD, causing the sliding carriage assemblies 150 to move in directions SA, as shown in FIG. 3B. If the cable moves in the direction opposite to the illustrated directions CD, the tension in the cable can cause damage to the cable and/or cause mechanical failure of various components of the system 100.

The amount of cable slack that the system 100 can control (e.g., the cable length that can be pulled out between the configurations shown in FIGS. 3B and 3C, referred to as “cable slack control length”) can depend on the minimum and maximum distance between the sliding carriage assemblies 150 and the number of pulleys 166 included in each of the sliding carriage assemblies 150. In some embodiments, the cable slack control length can be at least 1 meter (m), 2 m, 3 m, 4 m, 5 m, 6 m, 7 m, 8 m, 9 m, 10 m, or within a range of 1-10 m, 3-7 m, etc. In some embodiments, each of the cable take-up and let-out rates can be up to about 1 m/s.

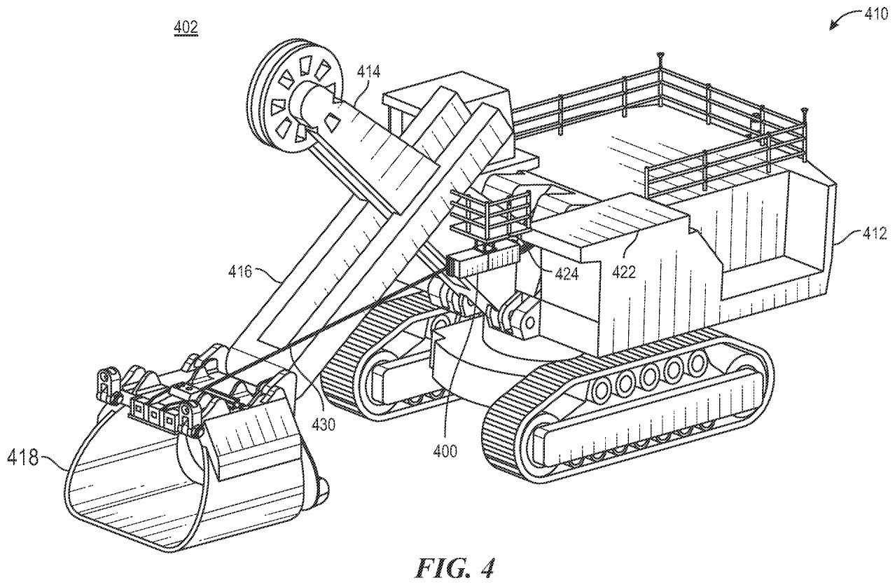

FIG. 4 is a perspective view of a mining shovel system 402 in accordance with embodiments of the present technology. The mining shovel system 402 can include a mining shovel 410, a cable slack control system 400 (“system 400”) attached to the mining shovel 410, and a cable 430. The mining shovel 410 includes a mining shovel body 412 including an upper surface 422 and a viewing deck 424, a boom 414 extending from the mining shovel body 412, a mining shovel arm 416 coupled to boom 414, and a bucket 418 coupled to the mining shovel arm 316. The system 400 can be an example of the system 100 discussed above with respect to FIGS. 1-3C. The cable 430 can extend from the mining shovel body 412 through the system 400 (portion of the cable 430 extending therebetween not shown), and to the bucket 418. In the illustrated embodiment, the system 400 is mounted to an underside of the viewing deck 424 (e.g., via the mounting brackets 104 illustrated in FIG. 1). In some embodiments, the cable 430 can include a braided cable sleeving composed of steel or other material.

In some embodiments, the system 400 can control cable slack between the system 400 and the bucket 418 by either providing additional cable length when the bucket 418 moves away from the mining shovel body 412 via the boom 414 and/or the mining shovel arm 416 or drawing in cable length when the bucket 418 moves closer to the mining shovel body 412. The system 400 can help keep the cable 430 taught and thereby prevent cable slack that leads to the cable 430 contacting and/or entangling with other components of the mining shovel system 402, the terrain, structures, and/or objects moving about the environment (e.g., a mining environment), which can cause chafing, abrading, and/or severing of the cable 430. It can also be important to avoid applying excessive force (e.g., tension, lateral force) on the cable 430, such as when the cable 430 is an electrical cable.

In some embodiments, the cable 430 can comprise a rope or other line configured to move the bucket 418 relative to the mining shovel arm 416. In some embodiments, the cable 430 can comprise an electrical cable connected to various electrical components (e.g., sensors, processors, light source, mining equipment) on the bucket 418 for supplying power, transferring data, transmitting signals, etc. In some embodiments, the sensors on the bucket 418 can include a multispectral or hyperspectral imaging head as described in U.S. patent application Ser. No. 17/992,626, entitled COMPOSITIONAL MULTISPECTRAL AND HYPERSPECTRAL IMAGING SYSTEMS FOR MINING SHOVELS AND ASSOCIATED METHODS, filed Nov. 22, 2022, and/or the sensors shown and described in U.S. Pat. Nos. 9,522,415, 10,036,142, and 10,982,414, each titled MINING SHOVEL WITH COMPOSITIONAL SENSORS, which are incorporated by reference herein in their entirety.

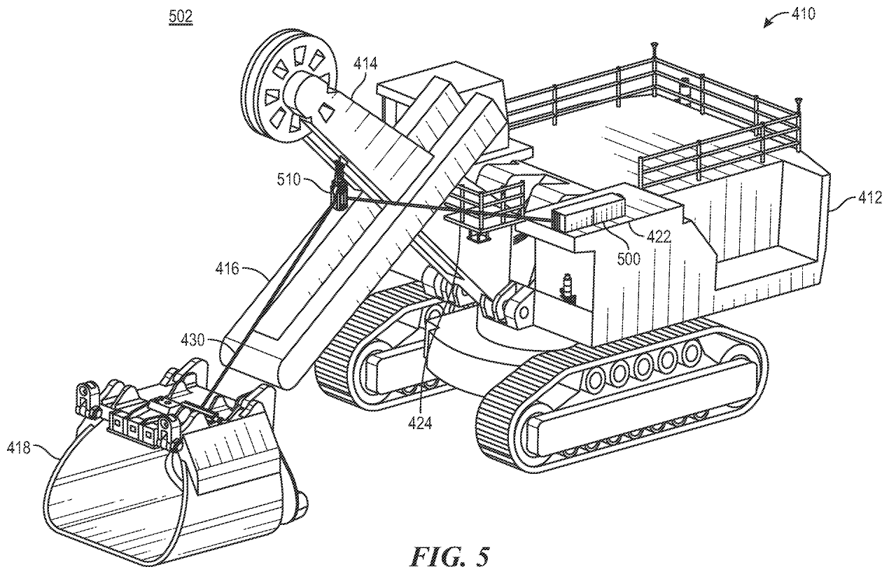

FIG. 5 is a perspective view of another mining shovel system 502 in accordance with embodiments of the present technology. The mining shovel system 502 can include the mining shovel 410, a cable slack control system 500 (“system 500”) attached to the mining shovel 410, a snatch roller fairlead assembly 510 (“assembly 510”), and the cable 430. The system 500 can be an example of the system 100 discussed above with respect to FIGS. 1-3C. The cable 430 can extend from the mining shovel body 412 through the system 500 (portion of the cable 430 extending therebetween not shown), through the assembly 510, and to the bucket 418. In the illustrated embodiment, the system 500 is attached to or placed on the upper surface 422 (e.g., via the base foots 102 illustrated in FIG. 1), and the assembly 510 is suspended from an underside of the boom 414.

In some embodiments, the assembly 510 can bi-directionally and axially guide the cable 430 at a higher elevation than the system 500 to avoid the cable 430 from damage via abrasion with other components of the mining shovel system 502. In some embodiments, the system 500 can help prevent cable slack between the system 500 and the assembly 510, and/or between the assembly 510 and the bucket 418 (or components mounted thereon). In some embodiments, the system 500 can be mounted elsewhere on the mining shovel 410 (e.g., a different part of the mining shovel body 412, on the boom 414, on the arm 416, etc.).

### FURTHER EXAMPLES

The following examples are illustrative of several embodiments of the present technology:
1. A cable slack control system, comprising:
a frame assembly having a first end portion and a second end portion opposite the first end portion, wherein the first and second end portions are configured to pass a cable therethrough;
a first sliding carriage assembly movably coupled to the frame assembly and configured to slide between the first and second end portions of the frame assembly, the first sliding carriage assembly including a first pulley array assembly, wherein the first pulley array assembly includes a first plurality of pulleys;
a second sliding carriage assembly movably coupled to the frame assembly and configured to slide between the first and second end portions of the frame assembly, the second sliding carriage assembly including a second pulley array assembly, wherein the second pulley array assembly includes a second plurality of pulleys; and
a biasing member coupled between the first and second sliding carriage assemblies and configured to bias the first and second sliding carriage assemblies away from one another,
wherein the cable is configured to be wound alternately around the first and second pulley array assemblies.
2. The system of example 1, wherein the biasing member is a first biasing member, and wherein the system further comprises:
an intermediate support structure coupled to the frame assembly between the first and second sliding carriage assemblies, wherein the first biasing member is coupled between the first sliding carriage assembly and the intermediate support structure, wherein the first biasing member is configured to bias the first sliding carriage assembly away from the intermediate support structure; and
a second biasing member coupled between the second sliding carriage assembly and the intermediate support structure, wherein the second biasing member is configured to bias the second sliding carriage assembly away from the intermediate support structure.
3. The system of any one of the proceeding examples, further comprising:
a plurality of shafts coupled between the first and second end portions of the frame assembly, wherein the biasing member is coupled to at least one of the shafts,
wherein the first sliding carriage assembly further includes a first sliding plate coupled to at least one of the first plurality of pulleys, wherein the first sliding plate includes a first plurality of apertures configured to slidably engage the shafts, and
wherein the second sliding carriage assembly further includes a second sliding plate coupled to at least one of the second plurality of pulleys, wherein the second sliding plate includes a second plurality of apertures configured to slidably engage the shafts.
4. The system of any one of the proceeding examples, wherein the first sliding carriage assembly further includes a first retention roller positioned above the first plurality of pulleys and a second retention roller positioned below the first plurality of pulleys, wherein the first and second retention rollers are configured to keep the cable on the first plurality of pulleys.
5. The system of any one of the proceeding examples wherein the first pulley array assembly further includes a first shaft extending through the first plurality of pulleys, wherein individual ones of the first plurality of pulleys are configured to rotate independently of one another on the first shaft, wherein the second pulley array assembly further includes a second shaft extending through the second plurality of pulleys, wherein individual ones of the second plurality of pulleys are configured to rotate independently of one another on the second shaft.
6. The system of any one of the proceeding examples, wherein the frame assembly includes:
a first pair of rollers coupled to the first end portion and configured to pass the cable therebetween; and
a second pair of rollers coupled to the second end portion and configured to pass the cable therebetween.
7. The system of any one of the proceeding examples, wherein each of the first and second sliding carriage assemblies includes between two and ten pulleys.
8. The system of any one of the proceeding examples, wherein each of the first and second sliding carriage assemblies includes between four and seven pulleys.
9. A system, comprising:
a cable with a first end configured to be coupled to a mining shovel body and a second end configured to be coupled to a bucket movably coupled to the mining shovel body; and
a cable slack control system coupled to the mining shovel and configured to receive the cable, comprising:
   a frame assembly having a first end portion and a second end portion opposite the first end portion, wherein the first and second end portions are configured to pass the cable therethrough;
   a first sliding carriage assembly movably coupled to the frame assembly and configured to slide between the first and second end portions of the frame assembly, the first sliding carriage assembly including a first pulley array assembly, wherein the first pulley array assembly includes a first plurality of pulleys;
   a second sliding carriage assembly movably coupled to the frame assembly and configured to slide between the first and second end portions of the frame assembly, the second sliding carriage assembly including a second pulley array assembly, wherein the second pulley array assembly includes a second plurality of pulleys; and
   a biasing member coupled between the first and second sliding carriage assemblies and configured to bias the first and second sliding carriage assemblies away from one another,
wherein the cable is configured to be wound alternately around the first and second pulley array assemblies.
10. The system of example 9 wherein the cable extends from the first end portion of the frame assembly to a first one of the first plurality of pulleys, to a first one of the second plurality of pulleys, to a second one of the first plurality of pulleys, and to a second one of the second plurality of pulleys, wherein the first and second ones of the first plurality of pulleys are adjacent, and wherein the first and second ones of the second plurality of pulleys are adjacent.
11. The system of any one of the proceeding examples wherein the cable slack control system is configured to provide a maximum cable slack length between 3 meters and 7 meters.
12. The system of any one of the proceeding examples wherein the cable slack control system is configured to be coupled to the mining shovel body.
13. The system of any one of the proceeding examples wherein the cable slack control system is configured to be coupled to an underside of a viewing deck of the mining shovel body.
14. The system of any one of the proceeding examples, further comprising an electrical component configured to be coupled to the bucket, wherein the cable includes an electrical cable operatively coupled to transfer power and/or signals to/from the electrical component.
15. The system of example 14 wherein the electrical component includes a sensor configured to measure characteristics in the bucket.
16. The system of any one of the proceeding examples wherein the cable includes a braided cable sleeving composed of steel.
17. A method of controlling cable slack, comprising:
mounting a cable slack control system to a structure, wherein the cable slack control system comprises:
   a frame assembly having a first end portion and a second end portion opposite the first end portion;
   a first sliding carriage assembly movably coupled to the frame assembly and configured to slide between the first and second end portions of the frame assembly, the first sliding carriage assembly including a first pulley array assembly, wherein the first pulley array assembly includes a first plurality of pulleys;
   a second sliding carriage assembly movably coupled to the frame assembly and configured to slide between the first and second end portions of the frame assembly, the second sliding carriage assembly including a second pulley array assembly, wherein the second pulley array assembly includes a second plurality of pulleys; and
   a biasing member coupled between the first and second sliding carriage assemblies and configured to bias the first and second sliding carriage assemblies away from one another,
routing a cable through the cable slack control system.
18. The method of example 17 wherein routing the cable comprises routing the cable through the first end portion, around individual ones of the first and second pluralities of pulleys, and through the second end portion.
19. The method of any one of the proceeding examples wherein routing the cable comprises routing the cable from a first one of the first plurality of pulleys, to a first one of the second plurality of pulleys, to a second one of the first plurality of pulleys, and to a second one of the second plurality of pulleys, wherein the first and second ones of the first plurality of pulleys are adjacent, and wherein the first and second ones of the second plurality of pulleys are adjacent.
20. The method of any one of the proceeding examples, further comprising:
applying tension in the cable, thereby causing the first and second sliding carriage assemblies to slide toward one another and compressing the biasing member; and
releasing tension in the cable, thereby allowing the biasing member to slide the first and second sliding carriage assemblies away from one another.

### CONCLUSION

In general, the detailed description of embodiments of the present technology is not intended to be exhaustive or to limit the invention to the precise form disclosed above. While specific embodiments of, and examples for, the present technology are described above for illustrative purposes, various equivalent modifications are possible within the scope of the present technology, as those skilled in the relevant art will recognize.

The teachings of the present technology provided herein can be applied to other systems, not necessarily the system described herein. The elements and acts of the various embodiments described herein can be combined to provide further embodiments.

Any patents, applications and other references, including any that may be listed in accompanying filing papers, are incorporated herein by reference. Aspects of the present technology can be modified, if necessary, to employ the systems, functions, and concepts of the various references described above to provide yet further embodiments of the present technology.

These and other changes can be made to the present technology in light of the above Detailed Description. While the above description details certain embodiments of the present technology and describes the best mode contemplated, no matter how detailed the above appears in text, the present technology can be practiced in many ways. Details of the present technology may vary considerably in its implementation details, while still being encompassed by the present technology disclosed herein. As noted above, particular terminology used when describing certain features or aspects of the present technology should not be taken to imply that the terminology is being redefined herein to be restricted to any specific characteristics, features, or aspects of the present technology with which that terminology is associated. In general, the terms used in the following claims should not be construed to limit the present technology to the specific embodiments disclosed in the specification, unless the above Detailed Description section explicitly defines such terms. Accordingly, the actual scope of the invention encompasses not only the disclosed embodiments, but also all equivalent ways of practicing or implementing the present technology.

I/We claim:

1. A cable slack control system, comprising:
a frame assembly having a first end portion and a second end portion opposite the first end portion, wherein the first and second end portions are configured to pass a cable therethrough;
a first sliding carriage assembly movably coupled to the frame assembly and configured to slide between the first and second end portions of the frame assembly, the first sliding carriage assembly including a first pulley array assembly, wherein the first pulley array assembly includes a first plurality of pulleys;
a second sliding carriage assembly movably coupled to the frame assembly and configured to slide between the first and second end portions of the frame assembly, the second sliding carriage assembly including a second pulley array assembly, wherein the second pulley array assembly includes a second plurality of pulleys; and
a biasing member coupled between the first and second sliding carriage assemblies and configured to bias the first and second sliding carriage assemblies away from one another,
wherein the cable is configured to be wound alternately around the first and second pulley array assemblies.

2. The system of claim 1, wherein the biasing member is a first biasing member, and wherein the system further comprises:
an intermediate support structure coupled to the frame assembly between the first and second sliding carriage assemblies, wherein the first biasing member is coupled between the first sliding carriage assembly and the intermediate support structure, wherein the first biasing member is configured to bias the first sliding carriage assembly away from the intermediate support structure; and
a second biasing member coupled between the second sliding carriage assembly and the intermediate support structure, wherein the second biasing member is configured to bias the second sliding carriage assembly away from the intermediate support structure.

3. The system of claim 1, further comprising:
a plurality of shafts coupled between the first and second end portions of the frame assembly, wherein the biasing member is coupled to at least one of the shafts,
wherein the first sliding carriage assembly further includes a first sliding plate coupled to at least one of the first plurality of pulleys, wherein the first sliding plate includes a first plurality of apertures configured to slidably engage the shafts, and
wherein the second sliding carriage assembly further includes a second sliding plate coupled to at least one of the second plurality of pulleys, wherein the second sliding plate includes a second plurality of apertures configured to slidably engage the shafts.

4. The system of claim 1, wherein the first sliding carriage assembly further includes a first retention roller positioned above the first plurality of pulleys and a second retention roller positioned below the first plurality of pulleys, wherein the first and second retention rollers are configured to keep the cable on the first plurality of pulleys.

5. The system of claim 1, wherein the first pulley array assembly further includes a first shaft extending through the first plurality of pulleys, wherein individual ones of the first plurality of pulleys are configured to rotate independently of one another on the first shaft, wherein the second pulley array assembly further includes a second shaft extending through the second plurality of pulleys, wherein individual ones of the second plurality of pulleys are configured to rotate independently of one another on the second shaft.

6. The system of claim 1, wherein the frame assembly includes:
a first pair of rollers coupled to the first end portion and configured to pass the cable therebetween; and
a second pair of rollers coupled to the second end portion and configured to pass the cable therebetween.

7. The system of claim 1, wherein each of the first and second sliding carriage assemblies includes between two and ten pulleys.

8. The system of claim 1, wherein each of the first and second sliding carriage assemblies includes between four and seven pulleys.

9. A system, comprising:
a cable with a first end configured to be coupled to a mining shovel body and a second end configured to be coupled to a bucket movably coupled to the mining shovel body; and
a cable slack control system coupled to the mining shovel and configured to receive the cable, comprising:
a frame assembly having a first end portion and a second end portion opposite the first end portion, wherein the first and second end portions are configured to pass the cable therethrough;
a first sliding carriage assembly movably coupled to the frame assembly and configured to slide between the first and second end portions of the frame assembly, the first sliding carriage assembly including a first pulley array assembly, wherein the first pulley array assembly includes a first plurality of pulleys;
a second sliding carriage assembly movably coupled to the frame assembly and configured to slide between the first and second end portions of the frame assembly, the second sliding carriage assembly including a second pulley array assembly, wherein the second pulley array assembly includes a second plurality of pulleys; and
a biasing member coupled between the first and second sliding carriage assemblies and configured to bias the first and second sliding carriage assemblies away from one another,
wherein the cable is configured to be wound alternately around the first and second pulley array assemblies.

10. The system of claim 9 wherein the cable extends from the first end portion of the frame assembly to a first one of the first plurality of pulleys, to a first one of the second plurality of pulleys, to a second one of the first plurality of pulleys, and to a second one of the second plurality of pulleys, wherein the first and second ones of the first plurality of pulleys are adjacent, and wherein the first and second ones of the second plurality of pulleys are adjacent.

11. The system of claim 9 wherein the cable slack control system is configured to provide a maximum cable slack length between 3 meters and 7 meters.

12. The system of claim 9 wherein the cable slack control system is configured to be coupled to the mining shovel body.

13. The system of claim 9 wherein the cable slack control system is configured to be coupled to an underside of a viewing deck of the mining shovel body.

14. The system of claim 9, further comprising an electrical component configured to be coupled to the bucket, wherein the cable includes an electrical cable operatively coupled to transfer power and/or signals to/from the electrical component.

15. The system of claim 14 wherein the electrical component includes a sensor configured to measure characteristics in the bucket.

16. The system of claim 9 wherein the cable includes a braided cable sleeving composed of steel.

17. A method of controlling cable slack, comprising:
mounting a cable slack control system to a structure, wherein the cable slack control system comprises:
a frame assembly having a first end portion and a second end portion opposite the first end portion;
a first sliding carriage assembly movably coupled to the frame assembly and configured to slide between the first and second end portions of the frame assembly, the first sliding carriage assembly including a first pulley array assembly, wherein the first pulley array assembly includes a first plurality of pulleys;
a second sliding carriage assembly movably coupled to the frame assembly and configured to slide between the first and second end portions of the frame assembly, the second sliding carriage assembly including a second pulley array assembly, wherein the second pulley array assembly includes a second plurality of pulleys; and
a biasing member coupled between the first and second sliding carriage assemblies and configured to bias the first and second sliding carriage assemblies away from one another,
routing a cable through the cable slack control system.

18. The method of claim 17 wherein routing the cable comprises routing the cable through the first end portion, around individual ones of the first and second pluralities of pulleys, and through the second end portion.

19. The method of claim 17 wherein routing the cable comprises routing the cable from a first one of the first plurality of pulleys, to a first one of the second plurality of pulleys, to a second one of the first plurality of pulleys, and to a second one of the second plurality of pulleys, wherein the first and second ones of the first plurality of pulleys are adjacent, and wherein the first and second ones of the second plurality of pulleys are adjacent.

20. The method of claim 17, further comprising:
applying tension in the cable, thereby causing the first and second sliding carriage assemblies to slide toward one another and compressing the biasing member; and
releasing tension in the cable, thereby allowing the biasing member to slide the first and second sliding carriage assemblies away from one another.
